(19) United States
(12) Patent Application Publication
(10) Pub. No.: US 2006/0170546 A1
(43) Pub. Date: Aug. 3, 2006

(54) 'FIND IT FAST NOW' is a remote control device used to locate 'lost' property by electronically triggering a transponder that has been previously affixed to the property

(76) Inventor: Edwin Joseph Clifford, Anacortes, WA (US)

Correspondence Address: Edwin Joseph Clifford, 4206 Glasgow Way, Anacortes, WA, 98221, US

(21) Appl. No.: 11/039,493

(22) Filed: Jan. 21, 2005

(51) Int. Cl. G08B 1/08

(52) U.S. Cl. 340/539.32

(57) ABSTRACT

The FIND-IT-FAST-NOW electronics system consists of a remote control Interrogator and five (5) frequency sensitive Responders utilizing existing ‘remote control’ technology, and containing design features that provide a new utility application to assist people to locate their ‘misplaced property. Firstly, each of the five (5) Responders is previously physically attached to five different objects of personal property that the user feels are most susceptible to misplacement. When a ‘pre-selected’ piece of personal property, with the Responder attached, is ‘misplaced’ the user may locate it by pressing the appropriate remote control Interrogator switch. The activation of the Interrogator switch transmits a signal that is accepted by only one of the five (5) Responders. Upon receipt of the Interrogator's transmitted signal the Responder circuitry initiates a signal with an audible range of 25 meters that is sufficiently loud to enable the user to locate the misplaced item.

This Specification is a ‘Continuation in Part’, initiated as the result of direction from UNITED STATES PATENT AND TRADEMARK OFFICE-FORMALITIES LETTER, CONFIRMATION NO. 2709, dated Mar. 3, 2005, a copy of which is an enclosure to this document.

### INVENTOR'S BIBIOGRAPHIC DATA

| | |
|---|---|
| Name:: | Edwin Joseph Clifford |
| Street of Mailing Address:: | 4206 Glasgow Way |
| City of Mailing Address:: | Anacortes |
| State or Province of Mailing Address:: | WA |
| Country of Mailing Address:: | US |
| Postal or Zip Code of Mailing Address:: | 98221 |
| Telephone:: | (360) 299 8603 |
| E-Mail address:: | edwinjclifford@verizon.net |

### CROSS REFERENCE TO RELATED APPLICATIONS

FIND-IT-FAST-NOW doesn't cross reference to, or conflict with any related applications.

### STATEMENT REGARDING FEDERALLY SPONSORED RESEARCH OR DEVELOPMENT

No part of this invention was conceived with the inventor using ideas or materials derived from “Federally sponsored research or development.

### BACKGROUND OF THE INVENTION

This invention (FIND-IT-FAST-NOW) is a new application based upon technology within the field of ‘Remote Controls’, used to control specific aspects of military and civilian electronics systems, for the past 60 years.

I became involved in the development of this device (FIND-IT-FAST-NOW) at the age of 76 when I began to ‘lose things’. Conversation with friends of mine, within my age category, indicated that I was not alone in this quandary. So I sat down at my computer and developed “FIND-IT-FAST-NOW”, which is a ‘Remote Control’ application that I've not seen in the marketplace. “FIND-IT-FAST-NOW” is a simple to operate device that hopefully will be of some use to 40,000,000 or so old folks such as myself, who have a tendency to lose things.

### BRIEF SUMMARY OF THE INVENTION

FIND-IT-FAST-NOW is a, simple to operate, electronic system used to locate missing objects, such as eyeglasses, keys, TV remote controls, wallets, purses, and all other objects deemed of value by an individual.

FIND-IT-FAST-NOW consists of a remote control Interrogator and five (5) Responders. One—of each—of the five (5) Responders is physically attached, by the user, to each of five objects selected by the user. The objects may, as an example, include eyeglasses, keys, TV remote controls, wallets, purses, or other personal objects pre-selected by the user as susceptible to misplacement. An adhesive strip located at the base of each Responder permits user attachment of the Responder to the selected objects.

The individual Responders react to an electronic signal from the Remote Control Interrogator when the user desires to locate an object that has been misplaced or lost. The user depresses the appropriate switch, of the five numbered and color coded switches on the face of the Remote Control Interrogator, sending a signal to the selected Responder. The selected Responder answers the Remote Control Interrogator's query with an audible sound each time the switch is pressed, thus enabling the user to physically locate the object.

FIND-IT-FAST-NOW operational aspects are graphically described in the image below.

[image]

### BRIEF DESCRIPTION OF THE SEVERAL VIEWS OF THE DRAWING

1/3 Remote Control Interrogator, Dimensional Drawing

FIG. 1 Dimensional Drawing, Top View

FIG. 2 Dimensional Drawing, Bottom View

FIG. 3 Dimensional Drawing, Side View

2/3 Responder, Dimensional Drawing

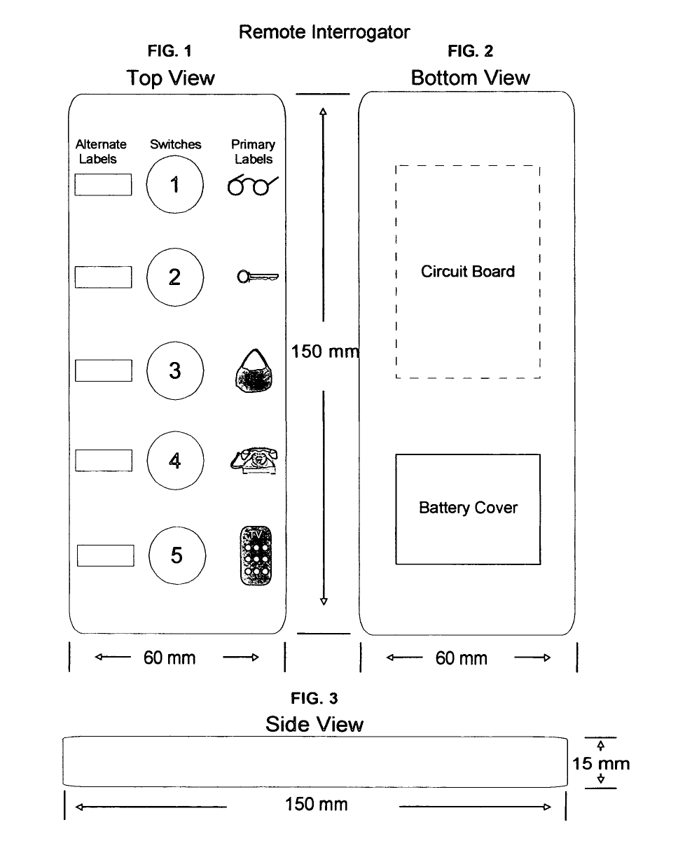

FIG. 1 Dimensional Drawing, Top View

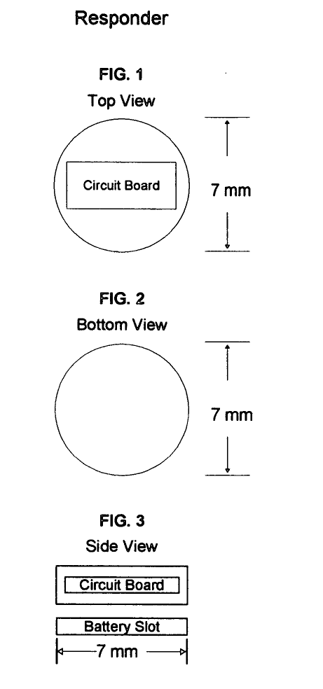

FIG. 2 Dimensional Drawing, Bottom View

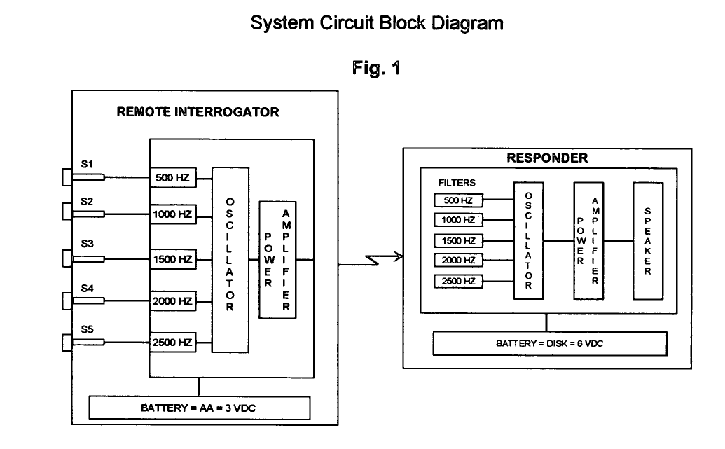

FIG. 3 Dimensional Drawing, Side View

3/3 System Circuit Block Diagram

FIG. 1 System Circuit Block Diagram

### DETAILED DESCRIPTION OF THE INVENTION

FIND-IT-FAST-NOW is an electronic system designed to provide, to users, the capability to locate missing or misplaced objects, such as eyeglasses, keys, purses, wallets, etc.

The system is composed of a remote control Interrogator and five (5) Responders. The Interrogator has five color-coded switches on the front panel that are used to query each of five (5) unique color-coded Responders through the transmission of unique frequencies that are compatible to only the matching color-coded Responder.

Each one of the five (5) Responders is physically attached, using a self-contained adhesive strip, to the users pre-selected objects that are felt, by the user, to be susceptible to loss or misplacement.

In the event that the user misplaces an item, as an example the key to their front door, the user merely depresses the Interrogator's front panel Switch number 2, which is color-coded ‘Blue’. Depression of the Interrogator's ‘Blue’ switch arranges the Interrogator's circuitry to provide the transmission of a 1000 Hz audio signal, with a range of 25 meters, whose function is to trigger the ‘Blue’ Responder. The ‘Blue’ Responder circuitry electronically passes the Interrogator's transmitted 1000 Hz signal, through a filter that will pass only the 1000 Hz Interrogator transmitted signal. All other Interrogator transmissions that are other than 1000 Hz will be blocked by the ‘Blue’ responder's filter circuitry.

Depression of the Interrogator's ‘Blue’ switch (S2) initiates the transmission of a 1000 Hz signal, from the Interrogator to the Responder, that is passed through the ‘Blue’ Responders 1000 Hz filter. Passage of the 1000 Hz signal through the Responder's filter circuit activates the Responder's circuitry and the Responder initiates an audible signal using its speaker circuit driven by a power amplifier. Each time the Interrogator's ‘Blue’ switch S2 is depressed transmitting a 1000 Hz signal to the Responder, the ‘Blue’ Responder circuitry initiates an audible signal enabling the user to locate the missing or misplaced object—in this case the key to their home's front door.

There are five (5) Responders, each of which may be affixed via a self-contained adhesive strip, to an object or item of the user's choice, based upon their judgment of which object has the highest probability of being lost or misplaced.

The remote control Interrogator color-coded switches—S1 through S5 are also identified by icons, representing: S1 (Red)=eyeglasses; S2 (Blue)=keys; S3 (Yellow)=purse or wallet; S4 (Green)=Telephone; and, S5 (Purple)—TV remote control. Each of the five Responders is also color-coded Red, Blue, Yellow, Green and Purple to match the transmitted Interrogator frequencies remote control Interrogator's switches, S1 through S5. Additionally, each switch, S1 through S5 may be ‘otherwise’ identified (from the icons) by writing the name of different objects on the remote control Interrogator's white ID panels adjacent to each switch.

Using the Icons to locate missing or misplaced objects:

1. If the user's ‘glasses’ are missing depress Interrogator switch S1.

2. If the user's ‘keys’ are missing depress Interrogator switch S2.

3. If the user's ‘purse’ is missing depress Interrogator switch S3.

4. If the user's ‘telephone’ is missing depress Interrogator switch S4.

5. If the user's ‘TV remote control’ is missing depress Interrogator switch S5.

Using the white ID Panels to locate missing or misplaced objects:

Any one, or all of the ID panels may be used in lieu of the Icons if the user desires. The user simply writes the description of an object within the ID Panel and then physically attaches the desired color-coded (Red, Blue, Yellow, Green or Purple) Responder to the object described within the ID Panel. This procedure may be followed for up to five (5) objects of personal property whose description has been previously written in the ID panels by the user.

Further, the remote control Interrogator Switches S1 through S5 are physically identifiable by coded raised hemispheres (1 mm) located at the bottom, center of each switch, to assist the visually challenged in the location of missing objects.

Each of the five (5) Responders contains a circuit board, a disc battery for the application of power to the circuit board, and self-contained adhesive strips. The Responders are 7 mm in diameter, 7 mm in height, and may easily be affixed to selected objects by the user. The relatively small size of each Responder enables this device to be relatively inconspicuous to the user once each Responder is affixed to the selected objects.

The remote control Interrogator measures: length=150 mm, width=60 mm; and height=15 mm, fitting comfortably in the user's hand, with ease of reach and dexterity in the operation of the switches.

Each of the five (5) Responders is unique, accepting only one, of the five possible specific transmitted frequencies from the remote control Interrogator controlled by the frequency bandwidth configuration of each Responders bypass filter.

The Responder's bypass filters providing input frequency discrimination to the remote control Interrogator's transmitted signals are configured as follows:

| | Interrogator | | | Responder | | |
|---|---|---|---|---|---|---|
| | Transmitted | | | Received | | |
| | Color | | VC | Color | | VC |
| Switch | Code | Frequency | Code* | Code | Frequency | Code* |
| S1 | Red | 500 Hz | 0 | Red | 500 Hz | 0 |
| S2 | Blue | 1,000 Hz | 00 | Blue | 1,000 Hz | 00 |
| S3 | Yellow | 1,500 Hz | 000 | Yellow | 1,500 Hz | 000 |
| S4 | Green | 2,000 Hz | 0000 | Green | 2,000 Hz | 0000 |
| S5 | Purple | 2,500 Hz | 00000 | Purple | 2,500 Hz | 00000 |
| *VC Code = Visually Challenged assistance devices. These devices are raised hemispheres, 1 mm in diameter and 1 mm in height, located on the Interrogator's switches, as well as, each of the five (5) Responders. The physical coding may be used by ‘visually challenged’ people to determine which remote control Interrogator switch to depress to find ‘previously selected’ objects, as well as, determining the identity of each Responder for proper system operation and | | | | | | |
| # subsequent location of ‘pre-selected’ objects. | | | | | | |

1. What I claim as my invention is an electronics system I've named FIND-IT-FAST-NOW, which is designed to locate property that has been misplaced or lost by the owner. My invention is composed of a remote control Interrogator (transmitter) and five (5) Responders (receivers) and is designed to enable people to locate ‘missing’ or ‘misplaced’, items of personal property. FIND-IT-FAST-NOW is simple and straightforward in concept, as well as, easy to use. FIND-IT-FAST-NOW will be of significant assistance to people who are presently suffering memory problems, and as a result of this ‘forgetfulness’ are experiencing the loss of objects that are important to them. I base the veracity of this statement regarding ‘forgetfulness’ upon my own experience of ‘misplacing’ objects of personal property, such as car keys, eyeglasses, etc., as I approach my 77^{th} birthday.

2. The FIND-IT-FAST-NOW system has the capability of assisting many of America's 40,000,000 ‘senior citizens’ to locate their ‘misplaced’, objects of personal property, that they desperately need to function in everyday life. This property may take the form of keys, eyeglasses, wallets, purses, telephones, remote controls, as well as, many other possessions deemed important to the user, that may be readily and quickly located through the use of this electronics system I've named FIND-IT-FAST-NOW.
